(19) United States
(12) Patent Application Publication
(10) Pub. No.: US 2003/0102205 A1
(43) Pub. Date: Jun. 5, 2003

(54) Mechanical switching contact

(76) Inventors: Reinhold Baertl, Regensburg (DE); Gunter Kloth, Saal (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/332,355

(22) PCT Filed: Sep. 18, 2001
(86) PCT No.: PCT/EP01/10759

(30) Foreign Application Priority Data
Oct. 13, 2000 (DE) 100-50-821.9

(51) Int. Cl. H01H 5/06

(52) U.S. Cl. 200/462

(57) ABSTRACT

The invention relates to a mechanical switching contact for bipolar commutation comprising an insulating support having fixed contacts disposed thereon. Said contacts are switchable by means of a contact carrier which possesses a pivoting arm on the free end thereof with a respective conducting contact element. The whole mechanical switching contact is configured as a modular unit which can be assembled in an optional manner.

The invention relates to a mechanical switching contact for the double pole [bipolar] switchover, especially under-load switchover of a tap changer [step switch].

A switchover arrangement for the switchover under load of a tap changer is known from WO 95/24724, which has a mechanical main switching contact and an also mechanical resistance switching contact. Both the main switch contact and also the resistance switching contact are comprised of two mutually interconnected actuatable individual interrupter contacts whereby each individual interrupter contact of the main switching contact and also of the resistance switching contact is electrically connected with the first load switching side and the respective other individual interrupter contact of both the main switching contact and also of the resistance switching contact are electrically connected with the second load switchover side. With this arrangement, the individual interrupter contacts of the main switching contact are switchable through a first changeover switch and the individual interrupter contacts of the resistance switching contact are switchable through a second changeover switch. There is thus a respective double-pole switchover by means of two changeover contacts.

From WO 96/309222 an under-load switchover for a tap changer [step switch] is known which technologically is proposed in the form of a double-pole switch having mechanical contacts pivotable in a lever-like manner about a pivot point. In addition, spring-loaded toggle levers are provided which act upon the rotatably mounted mechanical contacts in such manner that these can assume two switching positions-on either side of a dead point. The two movable contacts are arranged in the same horizontal plane at the outer region of the load switch for each phase.

This known configuration of the mechanical switching contacts for double-pole interruption is however complex and technologically expensive, requires precise adjustment after mounting and needs for that purpose a relatively large space.

It is the object of the invention therefore to provide a mechanical switch contact for the double pole [bipolar] switchover which is of simple construction and has the smallest possible number of parts to facilitate mounting and therefore has a modular configuration so that it is composed of a self-standing component which can be built into a device for switching over under load without further adjustment or matching efforts and in addition will occupy the smallest possible space.

This object is achieved with a mechanical switching contact having the features of the first patent claim. The dependent claims concern especially advantageous features of the invention.

The important advantage of the mechanical switching contact of the invention resides in its extraordinarily compact and simple construction. With fewer parts it allows both the mechanical main switching contact as well as the mechanical resistance switching contact to be prefabricated as identical modular components. For the main switching contact as well as for the resistance switching contact the same modular mechanical switching contacts are useable;

the main switch contact and resistance switching contact of each phase can be realized in a simple manner as common components of two identical, mutually connected modular switch contacts according to the invention.

The invention is described below in greater detail by way of example based upon drawings.

They show:

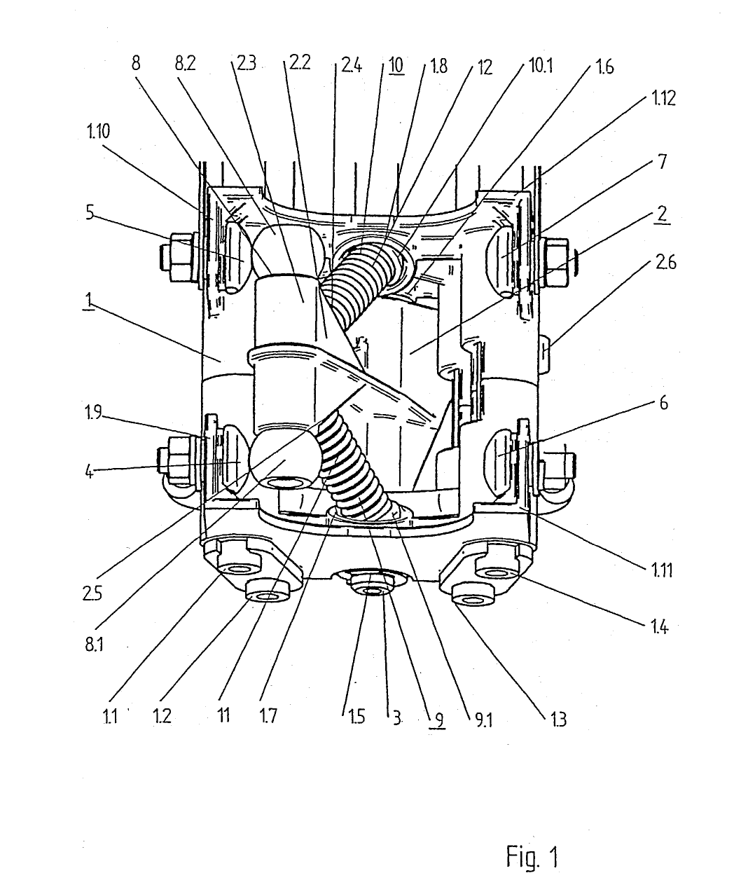

FIG. 1 a mechanical switch contact in accordance with the invention in a perspective illustration

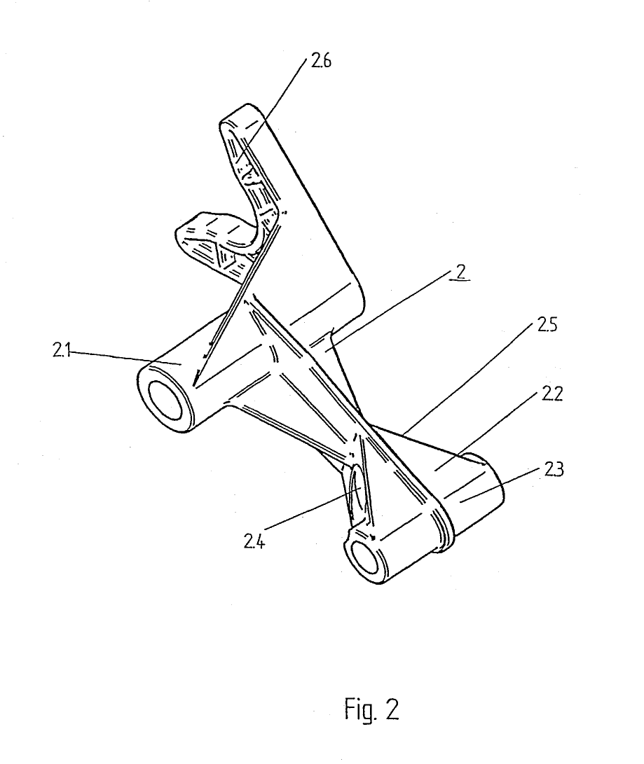

FIG. 2 a contact carrier of the switch contacts illustrated in FIG. 1 shown by itself

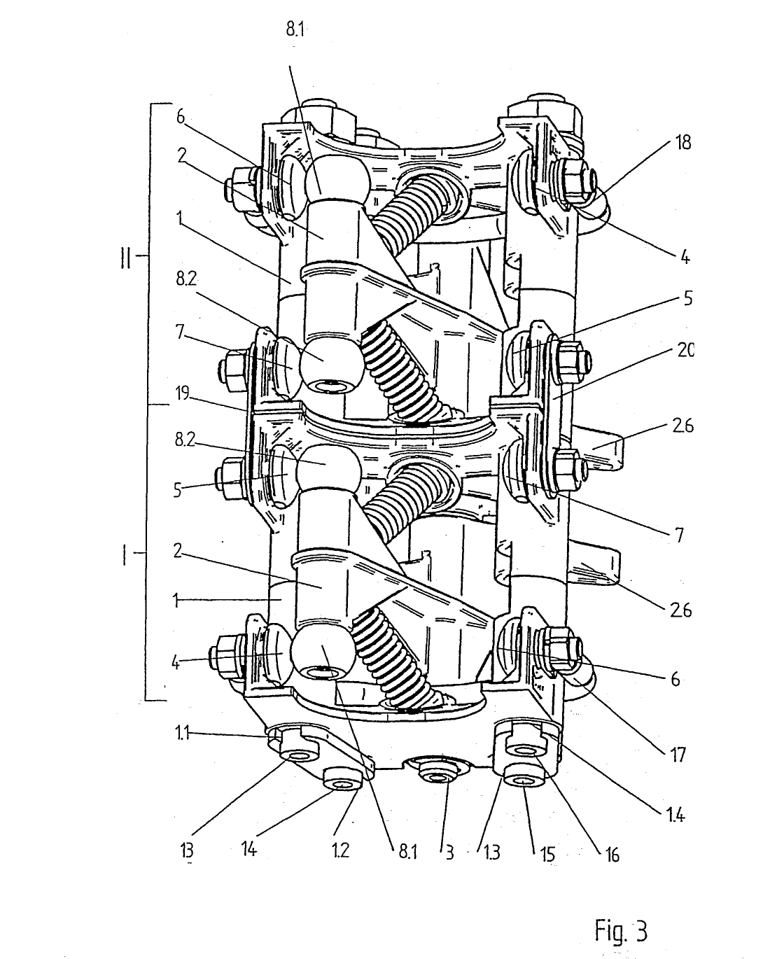

FIG. 3 a combination of two switch contacts of the invention according to FIG. 1 as a unitary single phase component for the main switch contact and the resistance switch contact

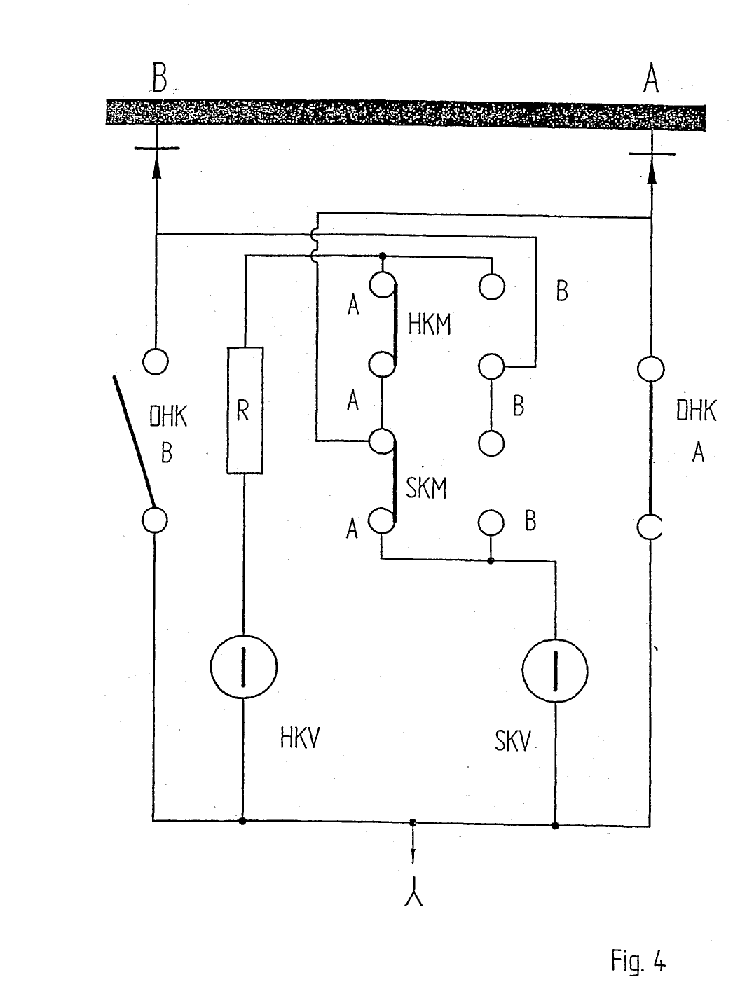

FIG. 4 a circuit of the load switch of a tap changer as can be achieved with the mechanical switch contacts according to the invention.

Initially the mechanical switch contact shown in FIG. 1 according to the invention will be described in greater detail. It has a carrier 1 of insulating material on which the further components described subsequently are carried. The insulating carrier 1 is provided with longitudinal guides 1.1 . . . 1.4 which run parallel to one another in the form of throughgoing bores which will be referred to further again below. In addition it has two bearing locations 1.5 and 1.6 in which a contact carrier 2 is rotatably journaled by means of a bearing pin 3. In the regions of the two bearing locations 1.5 and 1.6, lateral cup-shaped receivers 1.7 and 1.8 are provided which also will be discussed in greater detail subsequently. In addition, the insulated carrier has contact receivers 1.9 . . . 1.12 in which the fixed contacts 4 . . . 7 are disposed.

The contact carrier 2 which is illustrated by itself in FIG. 2 is rotatably mounted in the insulated carrier 1 by means of a bearing 2.1 and the previously mentioned bearing pin 3. Each has a pivot arm 2.2 which is swingable about the bearing 2.1 and in turn has a contact receiver 2.3 on its free end. This contact receiver 2.3 is comprised of a through-going bore which runs parallel to the longitudinal axis of the bearing 2.1 or the bearing pin 3. Laterally in the region of the contact receiver 2.3 are respective abutment receivers 2.4 or 2.5 which are also cup-shaped. At its other opposite free end, the contact carrier 2 has a actuating contour 2.6. In the contact receiver 2.3, an electrically-conductive contact piece 8 is disposed which has on its both free ends contact rollers 8.1 and 8.2. These contact rollers 8.1 and 8.2 correspond respectively either with the fixed contacts 4 and 5 on one side of the insulated carrier 2 or the fixed contacts 6 and 7 on the other side of the insulated carrier 1 depending upon in which direction the contact carrier 2 is pivoted about the bearing 2.1.

Between the contact carrier 2 and the insulated carrier 1 there are also two telescoping guides 9 and 10 on both sides. These telescoping guides 9 and 10 are comprised of two tube segments slidable one within another. They have a respectively at one free end a pocket 9.1 or 10.1 with which they are respectively braced in one of the cup-shaped receivers 1.7 or 1.8 of the insulated carrier. At their respective other free ends, the telescoping guides 9 and 10 have each a spherical abutment with which they are braced in respective ones of the two abutment receivers 2.4, 2.5 on both sides of the contact carrier 2. In addition, surrounding the first telescoping guide 9 there is a prestressed compression spring 11 which is also braced between the cup-shaped receiver 1.7 and the abutment receiver 2.4 on the contact carrier 2. Around the second telescope guide 10 in a completely analogous manner a further prestressed compression spring 12 is arranged which in its turn is braced between the cup-shaped recess 1.8 and the other abutment 2.5 on the contact carrier 2.

In the position shown in FIG. 1, therefore, the two fixed contacts 4 and 5 are electrically connected via the contact rollers 8.1 and 8.2, which are electrically connected together by the contact piece 8. The actuation of the load switch uses a roller or the like which is introduced into the actuating contour 2.6 and runs on the latter so that the entire contact carrier swings downwardly against the force of the prestressed compression springs 11 and 12 about its bearing 2.1. As a consequence the two contact rollers 8.1 and 8.2 then connect the oppositely lying fixed contact 6 and 7. Through the telescoping guides 9 and 10 in combination with the described springs 11 and 12, a snap mechanism is obtained in a simple manner which on the one hand prevents the contact carrier 2 from assuming a nondefined intermediate position and on the other hand provides a sufficient contact pressure of the contact rollers 8.1 and 8.2 on the respective fixed contact. The lateral cups 9.1 or 9.2 of this telescoping guide 9 and 10, which are respectively engaged in the cup-shaped recesses 1.7 or 1.8 of the insulated carrier, function as spatial three-dimensional braces. The telescoping guides 9 and 10 vary in length in switchover, i.e. the swinging of the contact carrier 2 and therefore are formed to be telescopic, as well as in their spatial orientation.

In FIG. 3, two of these switch contacts according to the invention have been shown and are assembled to a complete mechanism switch unit for one phase of a load switch. In this case, one switch contact I functions as a main-switch contact and the other switch contact II has the resistance switch contact. Identical parts have been provided with identical reference characters—it can be noted that both modules are constructed completely identically. For reasons of clarity, in this drawing not all of the explained details have been provided with reference characters. In FIG. 3 as has been shown in FIG. 1 for a single switch contact, an asymmetrical design of the actuating contour 2.6 of the contact arm 2 has been selected. Here the two switching contacts I and II are rotated through 180° with respect to one another so that the two actuating contours are turned toward one another. This is however only one of many possible embodiment configurations. The connection of the two switch contacts I and II is effected by common connecting bolts 13 . . . 16 which pass through the respective longitudinal guides 1.1 . . . 1.4 and are threaded on both sides. It can be seen further from FIG. 3 that the respective oppositely lying fixed contacts 4 and 6 of each switch contact I and II are connected together by a respective connecting cable 17, 18. It should be noted further that the neighboring contacts 5 and 7 of each switch contact are on one side connected together by a first conductive connection 19 and the correspondingly neighboring fixed contact 7 and 5 on the other side are electrically connected together by a further conductive connection 20. Thus a double-pole switchover for an under-load switch of a tap changer [step switch] can be realized.

This is illustrated again in FIG. 4: in the upper part of the circuit the selector of the step switch [tap changer] has been schematically illustrated and permits a power-less selection of the new winding tap n+1 of the tap changer to which the switchover shall occur while the previous winding tap n is still electrically connected in circuit. Below it are the two sides of the switch A and B for switching over under load and between which, in the sequence, there should be an interruption-free switchover under load. Further therebelow the mechanical switch contacts are shown and, indeed, in the left branch, the main switching branch, the main switching contacts SK. The indices A or B indicate the respective arrangements corresponding individual contact on side A or side B of the load switch. In the right branch, the resistance branch, the resistance switch contacts HKM which are completely analogous, have been shown; for all of the indices the same applies. The broken line indicates the part of the circuit which is technically realized by both of the mechanical switch contacts I and II of the invention. Underneath it further in the main switch path, there is the first vacuum switching cell SKV which is connected in series and serves as a load discharger, in the resistance branch are the series circuit of a bridging resistance and a second vacuum switching cell HKV for load discharge L.

Reference Character 1 listing:

1 insulating carrier

1.1 longitudinal guide

1.2 longitudinal guide

1.3 longitudinal guide

1.4 longitudinal guide

1.5 bearing location

1.6 bearing location

1.7 cup receiver

1.8 cup receiver

1.9 contact receiver

1.10 contact receiver

1.11 contact receiver

1.12 contact receiver

2 contact carrier

2.1 bearing

2.2 pivot arm

2.3 contact receiver

2.4 abutment receiver

2.5 abutment receiver

2.6 actuating contour

3 bearing pin

4 fixed contact

5 fixed contact

6 fixed contact

7 fixed contact

8 contact piece

8.1 contact roller

8.2 contact roller

9 telescoping guide

9.1 cup

10 telescoping guide

10.1 cup

11 spring

12 spring

13 connecting bolt

14 connecting pole

15 connecting pole

16 connecting pole

17 connecting cable

18 connecting cable

19 conductive connection

20 conductive connection

1. A mechanical switch contact for the double-pole switchover, especially for a load switchover, of a step switch, with the following features:
it has an insulating carrier (1) on which pairwise fixed contacts (4, 5; 6, 7) are arranged also pairwise opposite one another
on the insulating carrier (1) a contact carrier (2) is rotatably mounted which has on one of its two free ends a pivot arm (2, 2) and which has an actuating contour (2.6) on its other free end
on the pivot arm (2, 2) an electrically conducting contact piece (8) is so arranged that depending upon the respective possible end position of the contact carrier (2) in a stationary state conductively connects two of the fixed contacts which are arranged pairwise adjacent one another on one of the two sides (4 and 5 or 6 and 7)
on both sides of the pivot arm (2, 2) telescoping guides (9, 10) each with a respective compression spring (11, 12) provided which respectively have one of their free ends braced against the contact carrier (2) and with the other free end braced upon the insulating carrier (1) such that the contact carrier (2) has a snap effect and by application of force to the actuating contour (2, 6) is swingable to jump from one stationary state into another stationary state.

2. The mechanical switch contact according to claim 1, characterized in that the telescoping guides (9, 10) with each a respective compressing spring (11 or 12) is braced each at one on their free ends on an abutment receiver (2.4, 2.5) on the contact carrier and with the respective other free end on a cup receiver (1.7, 1.8) on the insulating carrier (1) such that a three dimensional spatial mounting at the bracing points is produced.

3. The mechanical switch contact according to claim 1 and 2, characterized in that the insulating longitudinal guides (1.1 . . . 1.4) are such that at least two identical mechanical switch contacts are modularly connectable with one another.

4. The mechanical switch contact according to one of the preceding claims 1 to 3, characterized in that the contact piece (8) in the middle region in a contact receiver (2.3) of the pivot arm (2.2) is arrested on its two free ends has each a respective contact roller (8.1, 8.2) which each cooperates with a respective one of the fixed contacts (4 . . . 7).
